(19) United States
(12) Patent Application Publication
(10) Pub. No.: US 2022/0400593 A1
(43) Pub. Date: Dec. 22, 2022

(54) PLOUGH MODULE HAVING A PERFORATED PLATE

(71) Applicant: Huber Soil Solution GmbH, Wagna (AT)

(72) Inventor: Franz-Ferdinand Huber, Leibnitz (AT)

(21) Appl. No.: 17/774,155

(22) PCT Filed: Nov. 3, 2020
(86) PCT No.: PCT/EP2020/080784

§ 371 Date: May 4, 2022

(30) Foreign Application Priority Data
Nov. 7, 2019 (DE) 10 2019 217 245.8

(51) Int. Cl. A01B 5/14; A01B 15/10; A01B 15/16; A01B 49/02

(52) U.S. Cl. CPC A01B 5/14; A01B 15/10; A01B 15/16; A01B 49/025

(57) ABSTRACT

The invention relates to a plough module (1) for interchangeable mounting on a base frame of a plough device for ploughing a ground, wherein the plough module (1) comprises: a rotatable first cutting element (102) which is designed as a coulter disc and has a revolving first cutting edge (103), wherein the first cutting element (102) is designed in such a manner that a lateral region of a soil ridge in the ground can be cut by moving the plough module (1) on the ground along a ploughing direction, a second, flat cutting element (105) having a second cutting edge (106), wherein the second cutting element (105) is designed in such a manner that a ground region of a soil ridge in the ground can be cut by moving the plough module (1) on the ground along a ploughing direction, characterized in that the plough module (1) is designed as a ready-mounted unit, in which the second cutting element (105) follows, and comprising a first support structure (4), on which the first cutting element (102) is arranged, a second support structure (5), on which the second cutting element (105) is arranged and which is connected to the first support structure (4), and that the first support structure (4) has means for detachable attachment to a base frame (2) of a plough device (3), wherein actuators (26.1, 26.2) are provided for adjusting the angle about two defined axes of the first cutting element (102) and an actuator (26.3) is provided for adjusting the angle about one axis of the cutting element (105).

### CROSS-REFERENCE TO RELATED APPLICATION

This is the United States national phase of International Patent Application No. PCT/EP2020/080784, filed Nov. 3, 2020, which claims priority to German Application No. 10 2019 217 245.8, filed Nov. 7, 2019, the entire contents of each of which are hereby incorporated by reference herein.

### FIELD OF DISCLOSURE

The present disclosure relates to a plow module for interchangeable mounting on a base frame of a plow device for plowing a ground and to a plow device equipped with at least one plow module of this type.

### BACKGROUND

When plowing with a plow device of this type, which plow device is usually pulled by a tractor, so-called soil ridges are cut out from the ground. A soil ridge has a lateral region along which a first cutting element cuts or has cut. Furthermore, the soil ridge has a bottom region which connects the two lateral regions and is separated from the ground by means of a second cutting element. Correspondingly, the ground has a separating surface in the bottom region of the soil ridge (so-called furrow base). An approximately rectangular soil ridge is thus cut out from the ground, with a horizontal cutting plane (=furrow base) being created by means of the second cutting element and a vertical cutting plane (=furrow wall) being created by means of the first cutting element on the remaining ground. By cutting out the soil ridge, a furrow wall is formed in the ground, from which furrow wall the lateral region of the soil ridge was detached. The bottom region thus defines the vertically lowermost surface of the soil ridge at the time of separation from the ground.

It is pointed out that the terms “horizontal” and “vertical” as well as “above” and “below” refer to the arrangements and configurations of the plow devices and thus to the plow module according to the disclosure attached to them, wherein the plow device is considered to rest on the ground and, during the plow operation, to be movable along the tillage direction.

DE 3541490 A1 describes a ground tillage machine which has ground tillage tools that can be driven about upwardly directed axes. The ground tillage tools are designed as subsoil loosening devices in order to work intensively on the lower layers of the ground, to break them up and loosen them altogether. These subsoil loosening tools follow disk coulters arranged in front of them in the plowing direction, which disk coulters are provided to separate the ground. This known ground tillage machine is provided for loosening the ground, but not for cutting out and turning a soil ridge from a ground region to be plowed. Due to the fact that ground structures located below the surface can be loosened, the known ground tillage machine is also particularly suitable for loosening the ground, even if plants are already growing in the bottom region to be loosened.

A relevant plow device is known from DE 10 2017 102 683 A1. A rotatable first cutting element which is designed as a coulter disk and has a revolving first cutting edge is arranged on the base frame of this plow device, wherein the first cutting element is designed in such a manner that a lateral region of a soil ridge of the ground can be cut off by moving the plow device on the ground along a plowing direction. The plowing direction or tillage direction is defined as the direction along which the plow device is displaced over the ground. A second flat cutting element having a second cutting edge is also attached to the base frame and is arranged in front of the first cutting element in the plowing direction. The second cutting element is designed in such a way that the bottom region of the soil ridge can be cut off by moving the plow module on the ground along a plowing direction. When plowing with this plow device, the bottom region of a soil ridge to be formed is first cut by means of the second cutting element. The following first cutting element, which is designed as a cambered coulter disk, then cuts a lateral region of the soil ridge and places it in a turned manner in the furrow formed. A plow device of this type requires a significantly reduced tensile force compared to conventional plows having plow bodies and moldboards.

A disadvantage of a plow device according to DE 10 2017 102 683 A1 is that the various cutting elements are mounted individually on the base frame, which makes mounting or retrofitting on a conventional base frame for plows difficult. In addition, the spatial alignment of the two cutting elements to one another is complicated and their setting or adjustment is often only possible to a small extent. Furthermore, in the case of the known plow device, it is not possible to adapt to different grounds, so that the plowing result is not optimally adapted to the corresponding grounds in the case of changing grounds.

### GENERAL DESCRIPTION

The object of the disclosure is to provide a unit in which cutting elements combined to form a plow module separate and turn soil ridges from the ground to be plowed during plowing, which plow module can be exchanged or mounted on a base frame of a plow device and allows easy plowing and which can easily be adapted to changing ground conditions.

This object is achieved in that the plow module is designed as a ready-mounted unit and is provided with a first support structure on which the first cutting element is arranged and with a second support structure on which the second cutting element is arranged, i.e. the corresponding support structure carries the corresponding cutting element, and the two carrier structures are connected to one another, and in that the first support structure has means for detachable attachment to a base frame of a plow device, in which a plow module is provided, in which the second cutting element is arranged after the first cutting element in the plowing direction. The first cutting element can be pivoted about two axes that are different from one another, and its desired pivot angle and/or its cutting angle is adjustable.

According to a first aspect of the present disclosure, the plow module for a plow device for plowing a ground is described. The plow module has a first support structure on which a rotatable cutting element, e.g. a cambered disk, is arranged. A second cutting element, for example a further disk or a cutting blade arranged at a defined angle relative to the first cutting element is mounted on a second support structure which in turn is firmly connected to the first support structure. The rotatable first cutting element has a revolving first cutting edge and is designed in such a way that, when moving the plow device with the support structure on the ground along its plowing direction, i.e. the tillage direction, a lateral region of a soil ridge of the ground, in particular of a furrow wall, is cut off by means of a first cutting region of the first cutting edge. The first and second support structures are firmly connected to one another and are arranged together via the first support structure on the base structure of the plow device. The second cutting element has a second cutting edge, the second cutting element being arranged on the second support structure and being designed in such a way that when moving the plow module on the ground along the plowing direction, a bottom region of a soil ridge of the ground, in particular along a separating surface between the ground ridge and plow base, can be cut off by means of a second cutting region of the second cutting edge. The second cutting element is arranged relative to the first cutting element in the plowing direction such that the second cutting region is behind the first cutting region in the plowing direction.

According to the disclosure, both cutting elements can be adjusted individually or together in their corresponding position with regard to their cutting task relative to the soil, so that the corresponding engagement angle can be selected. The ground conditions, such as the ground structure, loam or sand content, can vary considerably from ground to be plowed to ground to be plowed. A substantial advantage of the plow according to the disclosure is that, compared to conventional plows, the required tensile force can be reduced the tensile force while at the same time improving plowing and crumbling of the ground. This is also an ecological aspect to the greatest extent, since less fuel is required with reduced tensile force. Measurements have shown that, depending on the ground, up to 25% reduced tensile force is possible with the plow according to the disclosure. It is therefore provided for the plow according to the disclosure that the first cutting element is designed to be pivotable about two different axes of rotation. The first cutting element is pivotable about an axis directed in the direction of the ground to be plowed. The movement of the cutting element about the pivot axis pointing in particular in the perpendicular direction toward the ground means that the first cutting element can be pivoted with respect to its cutting angle and is also adjustable to a desired cutting angle. When a body moves in water, for example, a movement of this type corresponds to a yaw movement. A second possibility of movement of the first cutting element is provided in that the first cutting element can be pivoted with respect to its pivot angle about an axis which points in the plowing direction. This pivot angle is also adjustable to any desired value depending on the ground conditions. Compared to the movement of a body in water, this would be a so-called rolling movement. Both movements of the first cutting element, i.e. a movement about an axis in the plowing direction and further a movement about an axis perpendicular to the plowing direction and perpendicular to the ground to be plowed are individually or jointly possible, i.e. also adjustable.

In addition, according to one embodiment, it is preferably provided that the second cutting element can be adjustably pivoted about an axis which runs perpendicularly to the plowing direction and substantially parallel to the bottom of the furrow. It can thus be achieved that the second cutting element determines the depth of the furrow base in the ground on the one hand and the pull-in force of the plow into the ground on the other by setting an angle of attack relative to the bottom of the furrow.

The main advantage of the plow according to the disclosure compared to a conventional plow with a conventional plowshare is that in the case of a conventional plowshare, the furrow side and the furrow base are cut from a single element and the soil ridge obtained is turned, whereby the element transitions in one pass due to its curvature from an substantially perpendicular lateral wall region to a substantially horizontal region of the furrow base. According to the disclosure, these two cut regions, i.e. the region for the furrow wall and the region for the furrow base, are now produced by separate cutting elements, so that the conventional plow is, so to speak, separated into two different cutting elements. Only because these two elements are separate is the separate setting of the respective cutting elements the basis for an extremely high degree of flexibility and optimization and adaptation of the new plow according to the disclosure for further reducing the tensile force in different ground conditions.

The respective cutting elements on the plow module can preferably be adjusted, preferably pivoted, relative to one another in relation to the position thereof. This represents a clear advantage over the known plow devices. For example, a plow module can be used in which the first cutting element for the lateral separation of the soil ridge is arranged in front of the second cutting element for the ground separation of the soil ridge. However, it is also possible for the two cutting elements to be adjusted synchronously with one another, for example simultaneously in the z-direction, as part of the free adjustment to one another. An adjustment of this type is required, for example, when the plowing depth is to be changed due to ground conditions or other circumstances. This means that the thickness of the soil ridge can be varied from the top of the soil to the furrow base.

A plow device, which represents a second aspect of the disclosure, preferably has a plurality of plow modules, for example three to eight modules on one plow side, i.e. six to 16 modules in total based on a base frame. In the known plow devices, the first cutting element for cutting the side of a soil ridge is arranged behind the second cutting element which cuts the ground of a soil ridge or of a furrow, from which ground the soil ridge is cut. This known arrangement was obviously chosen because the first cutting element, in interaction with a guide plate or in a design as a hollow disk, is responsible for turning the cut out soil ridge. For this purpose, the bottom of a furrow, i.e. the underside of a soil ridge, must already have been cut. Therefore, in the known devices, the second cutting element was arranged in front of the first cutting element with respect to its active blade. This arrangement allows the first cutting element to turn the soil ridge immediately after it has cut the lateral wall of the soil ridge, since the furrow base has already been cut. So that the first cutting element can reliably cut the side or, in a curved configuration, also prepare the soil ridge for turning and initiate turning, the drive or bearing or holder of the first cutting element must of course be provided on its rear side. However, this in turn means that the second cutting element and the first cutting element must each have separate carriers by means of which they are attached to the frame. This makes it considerably more difficult to adjust the two cutting elements relative to one another.

In contrast, in the present disclosure, the first cutting element, which cuts the side of the soil ridge, is arranged in front of the second cutting element, which cuts the bottom surface of the soil ridge or furrow. Normally this is not taken into account because a plow device in which the first cutting element for cutting the side of the soil ridge is arranged first in the pulling direction cannot also perform the function of turning, although the shape is designed as a hollow disk and in principle is provided for turning of the soil ridge. The bottom of the furrow has namely not yet been cut. This is precisely the advantage of the module according to the disclosure, that only two cutting elements have to be provided, without a guide plate or moldboard being required. The advantage according to the disclosure is now also that due to the fact that the first cutting element has the drive or the bearing or the support structure on its rear side and, when arranged in front of the second cutting element which also has a support structure, the two support structures of the first cutting element and of the second cutting element can be connected to one another, so that a module is created which can be attached to the support structure of the plow device with a single suspension. The decisive advantage is that a conventional plow device having plow bodies can be converted with little effort by dismantling the plow bodies and installing a corresponding module. Of course, the conventional base frames, also called plow beams, can be provided with the plow modules according to the disclosure at the factory.

Surprisingly, it has now been shown that with a plow device having a leading first cutting element as a hollow disk, cutting of the lateral region is possible without first turning, since the bottom of the furrow has not yet been cut. This is only done by the trailing second cutting element. If a plurality of modules of this type are arranged one behind the other in a plow device, it has been shown that already in the second module following the first module, seen in the plowing direction, the first cutting element not only cuts the side surface of the soil ridge there, but that the ground furrow is cut there by the first module. The desired function can thus be performed directly by the second module, namely that the first cutting element in the form of a hollow disk cuts the side surface of the soil ridge and can turn the soil ridge at the same time.

Due to the change in position of the first cutting element which can be adjusted with regard to the cutting angle and the pivot angle, when it is pivoted about an axis in the plowing direction and also or instead of such pivoting about an axis pointing perpendicular to the ground, the first cutting element can be adjusted with regard to different ground conditions and in connection with the ground conditions to an optimally low tensile force. This is generally not possible with conventional plowshares because the combination of both cutting tasks, cutting the side surface and cutting the furrow base, into a single element, i.e. of the plowshare, always represents a compromise which, in relation to the required tensile force, is worse than an optimized intervention and optimized implementation of the corresponding individual function of the corresponding cutting element.

With regard to the construction, it is possible to benefit from the fact that the support structure of the first cutting element points backward toward the support structure for the second cutting element, so that an easy attachment and connection of the two cutting elements to form a module is possible there. This also applies to the actuators for adjusting the pivot angle, cutting angle, or angle of attack of the cutting elements. For example, if the plow device has only one plow module, then on the very first pass in plowing a field, only that very first pass would be a pass cutting the side of the uncut soil ridge, but turning would not take place yet. However, as early as the second pass, turning of the laterally cut-off soil ridge would immediately take place by means of the first cutting element, since the second cutting element would have already cut off the furrow base in that region and thus the underside of the soil ridge. This results in significant advantages over conventional plow devices. Replacing conventional plow devices with plow bodies or adapting plow devices to the plow modules according to the disclosure is easily possible. Due to the modularity, it is also easily possible to quickly replace defective or other plow modules that have been adapted due to a changed ground structure on the plow device, or to carry out an unchanged pivot angle setting when the defects are detected in order to counteract these defects.

The plow module according to the disclosure is particularly advantageous if the positions of both the first and the second cutting element is adjustable. This results in an adjustability to the ground to be plowed as well as an adjustability of the two cutting elements to one another. The second cutting element is pivotable on the support structure, to which the first cutting element, which is preferably pivotable about two axes, is attached in order to direct the inclination of the second cutting element slightly downward when cutting through the ground, in order to prevent this cutting element cutting the bottom of the furrow from moving out during plowing while keeping the first cutting element in the ground. The first cutting element can be pivoted and displaced in a number of directions, i.e. it has a number of degrees of freedom in order to achieve a correspondingly optimal plowing result when the two cutting elements interact with one another.

The provision of a plurality of modules on a plow device also has the advantage that a larger width can be plowed in one pass with the device according to the disclosure. It is also useful to pivot cutting elements out of engagement when plowing the edge of a field to be plowed and the width for the last pass would otherwise be too great such that there is a risk of carrying out ground separation with the plow module arranged furthest to the side, for example of a piece of ground which might already be in the neighboring field. In order to avoid this, a situation of this type can be prevented by pivoting the corresponding cutting element(s) out of engagement.

The plow module according to the disclosure is coupled via the base structure of the plow device to a tractor which thus pulls the cutting elements through the ground along the plowing direction. The base structure can also be part of a carrying iron or a skid. Skids can also be completely dispensed with in the case of plow modules which consist of two cutting elements arranged on combined support structures, namely a first cutting element for cutting the side of a soil ridge and for turning and a second cutting element for cutting the furrow base. The support structure has metal beams and/or fiber composite elements. Furthermore, as will be described in detail below, the attached elements can be adjustably attached to the support structure.

The plow beam or the support structure which is formed from the first and the second support structure thus offers an attachment structure that is rigid but suitable for adjustment for the cutting elements on the plow modules as well as for additional components such as joints or adjustment elements. In other words, the cutting elements are fixed to the corresponding first or second support structure in such a way that no relative movement between the cutting elements is possible during plowing. If during plowing the second cutting element is pressed into the ground due to the cutting of the soil ridge, the first cutting element is simultaneously pressed into the ground by means of a pull-in force. However, the cutting elements can preferably also be adjustable relative to one another during plowing with regard to their adjustable pivot angles and, for example, also their height, which can be done, for example, electrically or hydraulically.

According to an embodiment, the first and/or the second cutting element are pivotally attached to the corresponding support structure, for example by means of a joint, so that the angle between the axis of rotation and the direction of extension of the second cutting edge can be adjusted and fixed in a desired position. In a further advantageous embodiment of the disclosure, the second support structure itself is pivotably connected to the first support structure via a joint. As a result, the angle of attack of the second cutting element is adjustable in relation to the plowing direction. The angle of attack is usually such that the leading cutting edge is directed slightly downward into the soil.

In a further embodiment, the first cutting element and/or the second cutting element is/are arranged so as to be pivotably and/or translationally displaceable on the corresponding support structure in order to adjust the angle of attack and the positions in relation to one another. Thus, depending on the ground conditions and depending on the desired tillage depth and intensity, an angle of attack of the second cutting element can be adjusted in relation to the plowing direction.

A device such as, for example, the joint described above is used to adjust the cutting element angle (disk angle) and allows adjustment of the cutting element inclination angle (vertical inclination relative to the furrow wall of the ground) and the cutting element direction angle (relative to the plowing direction, i.e. to the tractor driving direction). The cutting line of the cutting element between the first cutting edge and the furrow wall can be adjusted in height by means of an adjustable support. Accordingly, the vertical and/or horizontal distance between the first cutting element and the second cutting element can be variably adjusted. In other words, in a further embodiment, the first cutting element and the second cutting element can be arranged relative to one another such that the cutting region of the first cutting edge of the first cutting element is vertically spaced apart from the second cutting edge of the second cutting element. The cutting width or plowing width of a pass is adjustable by means of an adjustment in the horizontal direction. This adjustment in the width direction is preferably carried out by means of an adjustment element which is preferably designed as a push rod. By translatory displacement of the push rod, a lateral offset of the plow modules and thus the plowing width is adjusted or achieved via suitable transmission elements, based on the base frame. The push rod is preferably continuously adjustable hydraulically or electrically.

In an embodiment of the disclosure, it is preferred that a first cutting region is formed within a first cutting plane, and a second cutting region is formed in a second cutting plane, the first cutting plane and the second cutting plane forming an angle of 30° to 135°, in particular 45° to 110°, to one another. The desired angle can be set for this purpose in that the two cutting elements are pivotably mounted on the respectively associated support structure. Of course, a predetermined, fixed alignment of the two cutting planes is also within the scope of the disclosure.

The first cutting edge runs in a first cutting plane, while the second cutting edge runs in a second cutting plane. The first cutting element and the second cutting element are attached to the support structure relative to one another in such a way that the first cutting plane and the second cutting plane are not designed parallel and have an angle of more or less than 90° (opening angle) to one another. In other words, in a further embodiment, the first cutting element can be arranged in such a way that an angle forms between the axis of rotation of the first cutting element and a direction of extension of the second cutting edge (or a tangent to the second cutting region if the second cutting element forms a rotating disk) from about 0° to about ±30° degrees. In particular, the normal of the first cutting plane has a (directional) component which is parallel to a horizontal direction when the plow device is intended to rest on the ground. The axis of rotation of the cutting element is in particular parallel to the normal of the first cutting plane. Furthermore, the normal of the second cutting plane has a further (directional) component which is parallel to a vertical direction when the plow device is intended to rest on the ground. An angle between the normals can be selected between 45° degrees and 130° degrees, for example, in order to achieve a desired furrow pattern in the ground.

If the first cutting plane and the second cutting plane are approximately 90° to one another, the second cutting element presses the undercut soil ridge in the direction of the first cutting element. As a result, during the movement in the plowing direction, the soil ridge can be worked advantageously between the first cutting element and the second cutting element. The interaction of both rotating machine elements, i.e. the first and second cutting element, provides a preferred plowing result or “crumbling” (breaking up of clods). In addition, the strong lateral pull of the first cutting element, which has a negative effect on the tractor's line of pull, is largely compensated for by the counteraction of the second cutting element. The tractor thus stays on track without much countersteering.

The first cutting element is rotatably attached to the first support structure. Correspondingly, the first cutting element has a first axis of rotation about which the first cutting element rotates. The first cutting element is preferably designed as a cambered coulter disk and has a circular revolving line. The revolving first cutting edge is designed along the revolving line. By means of the first cutting edge, the lateral region of the soil ridge is separated from the furrow wall of the ground, and the soil ridge is diverted laterally at the same time. The revolving first cutting edge has a first cutting region. The first cutting region is that revolving portion of the first cutting edge which preferably comes into contact with the ground first and cuts it in the plowing direction. The first cutting element can have a diameter of from about 500 mm to about 800 mm. Furthermore, the first cutting element can have teeth, is centrally mounted, and can be adjusted in position relative to the first support structure and the second cutting element, preferably by means of a carriage.

It is of particular advantage if the first cutting element, which can be rotated about an axis of rotation, is cambered or has the shape of a cone or a truncated cone. This ensures that the separated soil ridge is rotated and deposited in the adjacent furrow created during a previous pass of a plow module. The axis of rotation of the first cutting element is adjusted at an angle to the plowing direction in such a way that the leading edge of the cutting element is lowered in relation to the plowing direction and the cutting element substantially extends obliquely to the plowing direction and thus to the soil ridge to be cut by it.

The first cutting element is automatically rotated when the plow device moves along the ground. In this case, frictional forces cause the first cutting element to be moved. The first cutting element is preferably dimensioned such that, during plowing, only the lower half of the first cutting element, which lower half is located below the first axis of rotation, penetrates the ground, so that frictional forces with the ground can induce the rotation.

The rotation of the cambered or plate-shaped first cutting element also has the effect that the separated soil ridge is lifted and at the same time diverted to the side. In particular, the separated soil ridge is in frictional contact with a first cutting surface of the first cutting element. The first cutting surface is that surface of the first cutting element which is formed within the first cutting edge. Furthermore, the first cutting surface is that surface which faces the separated soil ridge. The first cutting surface can be designed homogeneously without recesses or elevations. Furthermore, the first cutting surface (i.e. the lateral surface of the first cutting element) can form a cone shape or a truncated cone shape.

In a preferred embodiment, the second cutting element is designed as a round disk and is rotatably mounted, the second cutting edge being defined by the revolving edge of the second cutting element. Alternatively, the second cutting element can be realized by an adjustable cutting blade having a cutting edge that extends transversely to the plowing direction. The cutting element which is preferably toothed on its blade is preferably directed slightly backwards with its tip at a defined angle relative to the plowing direction, i.e. it has an angle of greater than 90° to the plowing direction. By means of the second cutting edge, the bottom region of the soil ridge is separated from the furrow base of the ground, undercut and, if necessary, lifted at the same time. In the case of a rotatable disk, the revolving second cutting edge has a second cutting region. The second cutting region is that revolving portion of the second cutting edge which comes in contact with and cuts the ground in the second place in the plowing direction.

The first cutting element, e.g. a cambered disk, cuts the soil ridge in a first vertical layer plane, for example at a tillage depth of about 15 to 35 cm from the ground surface, and directs the soil ridge in a previously formed furrow.

In the second, horizontal layer plane, which is at a tillage depth of approx. 15 to 35 cm from the ground surface, the soil ridge is cut horizontally, i.e. from the furrow base, by the second cutting element.

The distance between the two cutting planes (above: rotating first vertical cutting element; and below: second horizontal cutting element) can be adjusted by adjusting the rotating cutting element.

The effective plow body, consisting of the main components of the first cambered cutting element and the second flat cutting element, such as cutting blade or rotatable disk, roughly corresponds to an inclined, winding plane that is drawn through the ground. The separated soil ridge slides up and sideways along the cambered first cutting element on the inside thereof. This process involves compressing the top half of the soil ridge and stretching the bottom half. As a result, compressive, tensile, and torsional stresses arise within the soil ridge, which causes the ground to split up.

With the arrangement according to the disclosure of the second cutting element behind the first cutting element in the plowing direction, the frictional force which otherwise leads to a high required tensile force of the plow device can be reduced. Since the soil ridge, when cut by the first cutting element on its side, is already undercut from the furrow base by the second cutting element, the soil ridge is already being lifted and turned by the first cutting element. The second cutting region is in the plowing direction, for example between 1 cm and 50 cm, in particular 15 cm to 25 cm, behind the first cutting region. The substantially horizontal second coulter disk or the cutting blade comes into contact with the ground in second place and follows or lags behind the substantially vertically arranged first coulter disk or the cutting element. This arrangement of the second cutting element “undercuts” the furrow wall or the soil ridge to be plowed horizontally and thus facilitates the cleavage/furrow clearing considerably. The vertically arranged cambered first cutting element cuts off the horizontally pre-cut soil ridge by means of the downstream second cutting element during the subsequent pass and at the same time turns the soil ridge through the rotary movement of the hollow disk and places it sideways, preferably in the furrow.

The plow device thus allows a smooth plowing effect. The coefficient of friction compared to conventional rigid plow bodies is significantly reduced because the cutting element rotates as well. This concept provides an easy-to-pull, fuel-efficient plow that at the same time creates a constant furrow pattern that is almost ready for the seedbed. In addition, the coefficient of friction is reduced by the fact that the first cutting element in the form of the hollow disk has the holder in its hub region on its rear side, so that the inner surface of the hollow disk remains substantially smooth, i.e. it has hardly any protruding holder parts.

According to a further embodiment, the second cutting element is an actively rotatable cutting element, and the second cutting edge is a cutting edge revolving around the second cutting element. The second cutting element can be driven or rotated by means of an electric or hydraulic drive device.

According to a further embodiment, the first or second cutting edge of the first or second cutting element is cambered and serrated, for example formed as a concave disk. A cambered design means that indentations or elevations (serrations) are formed in the first or second cutting edge. An improved cutting action of the first or second cutting element when cutting off the soil ridge can thus be achieved. By means of the spherical cap-shaped design, in particular of the first cutting element, the soil ridge sliding along it can be turned, so that the attachment of a moldboard or guide plate can be dispensed with. It is advantageous if the first cutting edge of the first cutting element and/or the second cutting edge of the second, disk-shaped cutting element has/have recesses on the circumference. This results in a design in the manner of a circular saw blade, which penetrates the soil particularly easily and can be rotated by engaging with the soil.

By means of the plow device described, a saving in tensile force/fuel is made possible by the ease of pulling of the plow device, which saving can amount to up to 25% compared to known plows. Furthermore, the plow device can be used universally and works in almost all ground conditions because it can be adjusted to all ground conditions. In addition, the soil ridge is continuously broken up by the rotating movement of the coulter disk. This achieves the desired crumbling of the clod (breaking up of clods). The post-tillage steps can be reduced by the effect resulting from breaking up clods. This saves operational steps up to seedbed tillage. In addition, the ground is advantageously mixed. Furthermore, conventional standard components or standard additional tools, such as fertilizer inserts and disk coulters, are no longer necessary. The rotating first and/or second cutting element cause(s) less wear and thus lower spare parts costs. Due to this gentle tillage of the ground, humus-damaging metal abrasion from the cutting elements is largely avoided or reduced compared to a plow device with a conventional moldboard.

According to a further embodiment, the plow device has at least one additional plow module, also comprising a rotatable first cutting element having a revolving additional first cutting edge, and is designed in such a way that, when moving the support structure on the ground along the plowing direction, an additional lateral region of an additional soil ridge can be cut from the ground by means of the further plow module, and the further first cutting element can be rotated, so that the further soil ridge can be lifted by means of the further first cutting element.

With the embodiment described above, it is made clear that a plurality of plow modules can be arranged spaced apart and side by side in the plowing direction, i.e. along a direction orthogonal (in a horizontal plane) to the plowing direction. In this way, a large number of soil ridges arranged next to one another in the plowing direction can be cut out from the ground, lifted and, if necessary, turned over.

When arranging a large number or a plurality of corresponding plow modules and thus a corresponding number of cutting elements one behind the other in the plowing direction, due to the lateral offset of the individual plow modules to one another transversely to the plowing direction, a wider area can be plowed in one pass than is the case if only one single plow module is used in one pass. In turn, it is advantageous for the functionality of the plow device if the cutting elements are disengaged and can therefore be pivoted out of their adjusted position. This makes it possible, for example, to turn a trailing cutting element into a leading one. In the combination of a plurality of plow modules of a plow device, this can be useful or advantageous for different parameters such as, for example, ground conditions in the sense of an optimal adaptation.

With the plow device according to the disclosure, for example, with the upper rotatable cambered first cutting element, even without a guide plate and without a moldboard, a gentle and flat turning of the soil ridge of the ground up to, for example, 15 centimeters is made possible.

In one embodiment, the first cutting element and the second cutting element are arranged in an exchangeable manner (e.g. by means of screw connections) on the corresponding support structure. The first support structure is designed in such a way that it can be detachably mounted on the base frame of the plow device, which is preferably done using screw connections. Shear bolts can also be provided for stone protection. The mounting elements provided for this purpose, such as bores or pins, are preferably designed and arranged in such a way that they are compatible with commercially available base frames for plow devices. Thus, the plow module can easily be retrofitted to the base structure of a plow device instead of, for example, a plow body.

Due to the rotation of the first cutting element, the separated soil ridge is slightly lifted, turned, and discharged onto the furrow. When moving the plow device along the plowing direction, the soil ridge is turned in the plowing direction.

Due to the lifting of the soil ridge by means of the rotating first cutting element, the soil ridge can be stored behind the cutting element in an energy-efficient manner in the plowing direction.

In a particularly preferred embodiment of the plow module according to the disclosure, the second cutting element is designed as a fixed cutting blade. In this case, the cutting blade is designed as a flat, rectangular, straight, or curved blade which is attached to the second support structure at one end region. The attachment is preferably done by screwing, which also allows easy replacement of the second cutting element when worn. The cutting edge of the blade in its working position points in the plowing direction and is generally oriented transversely to this direction.

In an advantageous modification of this design, the cutting blade of the second cutting element is designed to be L-shaped, with a first bar of the cutting blade being aligned horizontally in the working position of the plow module and a second bar being aligned substantially perpendicular thereto. The first bar thus separates the bottom region of the soil ridge to be formed. While the second bar, which is vertical in the working position of the plow module, is in front of the first cutting element and facilitates its penetration into the ground, since it lies substantially in the same plane as the leading edge of the first cutting element. For reasons of mechanical robustness alone, it is expedient for the cutting blade to be designed in one piece. It is generally in the form of a flat blade with a sharpened edge on the front. The angle of attack of the blade with respect to the plowing direction may be adjustable to ensure that a desired depth of penetration of the plow module into the ground is achieved and maintained.

The disclosure also comprises a plow device, on the base frame of which at least one plow module according to the disclosure is arranged, preferably six to 16 plow modules of this type are arranged. In this case, the plow module is preferably firmly connected to the base frame via screw connections, with the connection taking place via the first support structure. It goes without saying that compatible attachment elements such as bores or threaded bolts must be formed on the base frame and on the first support structure. Alternatively, an adapter element can also be provided in order to be able to adapt and attach the plow module to different base frames of plows. The plow module can thus be easily mounted on a base frame or removed, for example, for maintenance purposes.

### BRIEF DESCRIPTION OF THE DRAWINGS

For further explanation and for a better understanding of the present disclosure, embodiments are described in more detail below with reference to the accompanying drawings in which:

FIG. 1 is a representation of a plow module in terms of its basic function according to an embodiment of the disclosure;

FIG. 2 is a schematic representation of a plow device in terms of its general operation according to an embodiment of the present disclosure during a plowing operation;

FIG. 3 shows a plow module with regard to the base structure thereof according to another embodiment of the disclosure, showing the alternative arrangement of a cutting blade and a coulter disk as the second cutting element;

FIG. 4 is a representation of a plow device according to the disclosure showing its base structure as a seedbed plow device having three plow modules in a further embodiment of the present disclosure;

FIG. 5 is a top view of a plow device according to FIG. 4, in which, for example, a plow body is exchanged by a plow module according to the disclosure in the sense of a retrofit;

FIG. 6 is a representation of two plow modules according to a further embodiment, which are arranged on both sides of the base frame;

FIG. 7 shows an arrangement according to FIG. 7 in a different perspective;

FIG. 8 is the representation of an embodiment with continuously variable cutting elements;

FIG. 9 shows an overall arrangement of a plow according to the disclosure with continuously adjustable actuators for the cutting elements; and

FIG. 10 shows an overall arrangement of a plow according to the disclosure as shown in FIG. 9 with additional cutting width adjustment.

Identical or similar components in different figures are provided with the same reference signs. The representations in the figures are largely schematic and are only exemplary.

### DETAILED DESCRIPTION

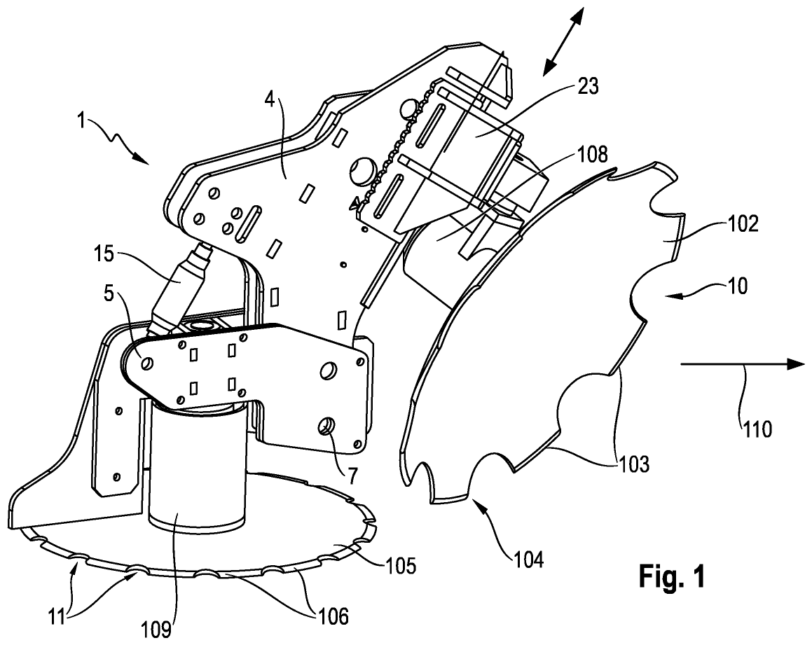

FIG. 1 shows a plow module for plowing a ground 120, in which plow module a first cutting element 102 in the form of a spherical cap-shaped hollow disk is arranged in the plowing direction in front of a second cutting element 105, one behind the other, in the form of a flat plate. The first cutting element 102 is provided for cutting the side surface of a soil ridge, whereas the second cutting element 105 arranged after the first cutting element 102 is designed as a flat disk which cuts the bottom of the furrow. Both cutting elements 102, 105 are joined together as a plow module by means of a support structure 4, 5. The support structure 4, 5 can be attached to a base frame (not shown), the second cutting element 105 being connected in an articulated manner to the first cutting element 102 via the support structure 4 thereof.

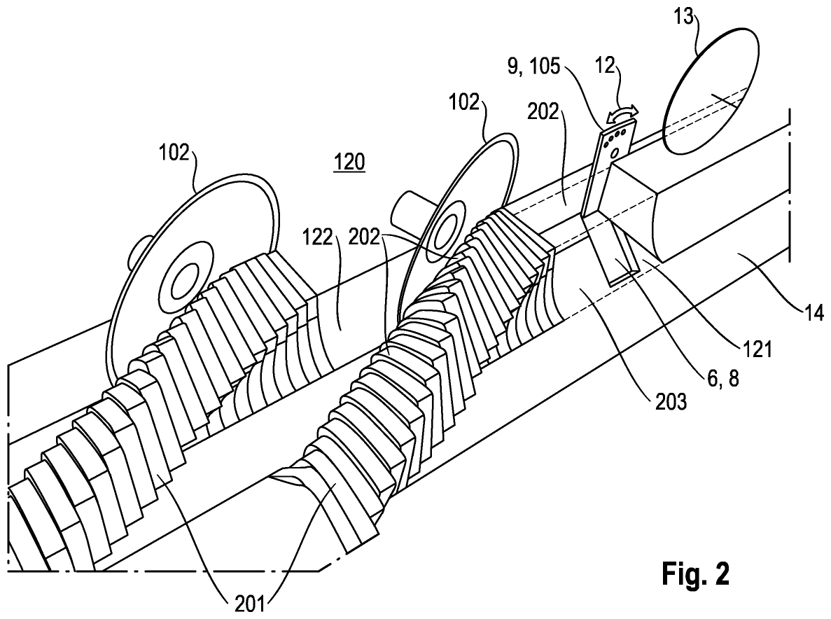

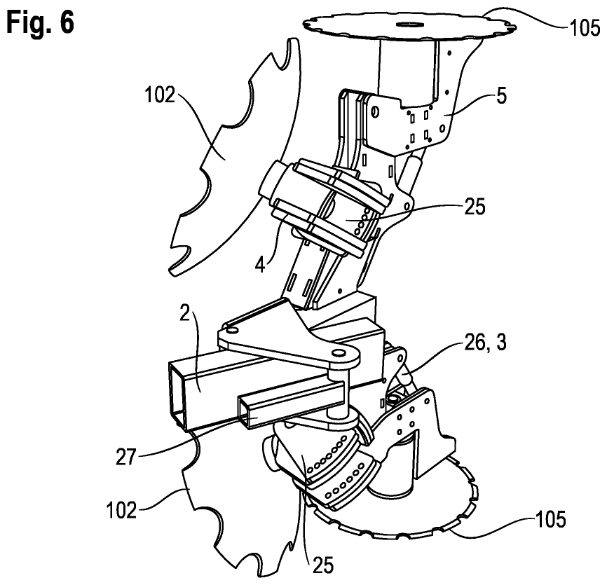

As shown in the base structure of the plow module 1 according to FIG. 1, a rotatable first cutting element 102 having a revolving, cambered first cutting edge 103 having a first cutting region 104 is arranged on a first support structure 4 and is designed in such a way that, when moving the support structure 4 on the ground 120 along the plowing direction 110, a lateral region 202 (see FIG. 2) of a soil ridge 201 of the ground 120 can be cut by means of a first cutting region of the first cutting edge 103, as shown in FIG. 2. The plowing direction 110 is defined as the direction along which the plow device 2 is displaced over the ground 120. A second cutting element 105 having a second cutting edge 106 having a second cutting region 107 is arranged on a second support structure 5 which is detachably connected to the first support structure 4 and is pivotable relative to the first support structure. The second cutting element 105 is designed in such a way that, when moving the support structure 5 on the ground 120 in the plowing direction 110, a bottom region 203 of a soil ridge 201 of the ground 120 can be cut off by means of a second cutting region of the second cutting edge 106, the second cutting element 105 being arranged in the plowing direction 110 relative to the first cutting element 102 such that the second cutting region is arranged after the first cutting region in the plowing direction. The second cutting region is thus spaced apart from the first cutting region by the distance x. Positioning actuators 26 (26.1, 26.2 and 26.3) for adjusting the angle of the cutting elements 102, 105 (see FIGS. 6 to 9) have been omitted for the sake of simplicity of illustration.

Since during plowing the base frame 3 of the plow module 1 is pressed with the first and second support structures 4 and 5 in the direction of the separating surface 121 of the ground 120, the first cutting element 102 is also pressed in the direction of a separating surface 121 so that the first cutting element 102 is maintained in the desired ground depth during plowing.

FIG. 2 shows a schematic representation of the substantial functional elements of a plow device according to an embodiment of the present disclosure during a plowing operation. Said FIG. 2 shows the correct spatial arrangement of the first and second cutting elements 102 and 105 as well as the formation and turning of soil ridges 201. The other components of the associated plow device 2 are not shown for the sake of clarity.

As shown in FIG. 2, so-called soil ridges 201 are cut out from the ground 120 during plowing. A soil ridge 201 has a lateral region 202 along which the first cutting element 102 cuts. Furthermore, the soil ridge 201 has a bottom region 203 which connects the two lateral regions 202 and is separated from the ground 120 by means of the second cutting element 105 which is shown in this case by way of example as a fixed cutting blade 6 in the shape of a double L. Correspondingly, the ground 120 has a separating surface 121, the so-called furrow base 121, on the bottom region 203 of the soil ridge 201. After the soil ridge 201 has been cut out, the furrow wall 122 can be seen in the ground 120, from which furrow wall the lateral region 202 of the soil ridge 201 was detached. The bottom region 203 thus defines the lowermost horizontal surface of the soil ridge 201 in the vertical direction at the time of separation from the ground 120. The lateral regions 202 of the soil ridge 201 define the lateral wall regions of the soil ridge 201 at the time of separation from the ground 120.

As shown in FIG. 1, the support structures 4 and 5 for the two cutting elements 102 and 105 are designed in such a way that at least the first cutting element 102 and the second cutting element 105 are firmly connected to the base frame 3 of a plow device 2. The first support structure 4 can be attached to a tractor via the base frame 3 of the plow device 2 in order to accordingly drive the cutting elements 102, 105 along the plowing direction 110. The plow module 1 has, for example, the first and second support structure 4, 5 which can be designed to be fixed or pivotable via joints.

The first and the second support structure 4 and 5 thus form a rigid attachment structure for the cutting elements 102, 105. The cutting elements 102, 105 are fixed to the support structures 4, 5 in such a way that no relative movement between the positions of the cutting elements 102, 105 is possible during plowing. If, according to the disclosure, the second cutting element 105 is pressed in the direction of the ground 120 due to the cutting of the soil ridge 201, the first cutting element 102 is also pressed into the ground 120 at the same time, since the two support structures 4, 5 are firmly connected to one another.

The first cutting element 102 and the second cutting element 105 are rotatably attached to the corresponding support structure 4 or 5. Correspondingly, the first cutting element 102 has an axis of rotation 108 about which the cutting element 102 rotates. The second cutting element 105 forms a second axis of rotation 109 about which the second cutting element 105 rotates. The first cutting element 102 and the second cutting element 105 are designed in this case, for example, as a spherical cap-shaped coulter disk or as a flat disk and have a circular revolving line. The corresponding revolving first cutting edge 103 and the second cutting edge 106 are designed along the revolving line. The lateral region 202 of the soil ridge 201 is separated from the furrow wall 122 of the ground 120 by means of the first cutting edge 103. The revolving first cutting edge 103 has a cutting region 104. The cutting region 104 is that revolving portion of the first cutting edge 103 which, in the plowing direction 110, comes into contact first with the ground 120 and cuts it. A bottom region 203 of the soil ridge 201 is separated from the ground 120 by means of the second cutting edge 106. The second cutting region of the second cutting edge 106 is that revolving portion of the second cutting element 105 which, in the plowing direction 110, makes second contact with the ground 120 or follows the first cutting element and cuts it. The double arrow 12 in FIG. 2 indicates that the second cutting element 105 is pivotably mounted on the second support structure 5 (not shown here). The pivoting allows adjustment of the angle of attack of the cutting blade 6 in relation to the plowing direction and thus the depth of penetration of the plow module 1 into the ground 120.

A rotatable disk coulter 13 can be arranged in front of the plow module 1 or connected to it, which disk coulter pre-cuts or opens the ground 120 in front of the vertical, second bar 9 of a cutting blade 6 and the first cutting element 102. This reduces the tensile force required for plowing, as does the wear on the cutting blade 6 and the subsequent first cutting element 102. The cutting blade cuts horizontally and vertically as a double or triple edge.

The first cutting element 102 is rotated when the plow device 2 moves along the ground 120. In this case, for example, frictional forces cause the cutting element 102 to be moved. The cutting element 102 is dimensioned such that during plowing only the lower half of the first cutting element 102, which is located under the axis of rotation 108, penetrates the ground 120, so that frictional forces with the ground 120 induce the rotation.

The rotation of the first cutting element 102 also causes the separated soil ridge 201 to be lifted. This is shown in FIG. 2 with the arrows indicating the conveying direction 123 of the soil ridge 201 along the plow device 2.

The separated soil ridge 201 is in frictional contact with a cutting surface 113 of the cutting element 102. The cutting surface 113 is that surface of the cutting element 102 which is formed within the first cutting edge 103 or is surrounded by it. Furthermore, the cutting surface 113 is that surface which faces the separated soil ridge 201. As shown in FIG. 1, the cutting surface 113 can be formed homogeneously without recesses or elevations.

Due to the lifting of the soil ridge 201 by means of the rotating cutting element 102, the soil ridge 201 can be conveyed into the adjacent furrow in an energy-efficient manner. This furrow was dug in a previous pass of a plow module as shown in FIG. 2.

According to FIG. 1, the first cutting element 102 and the second cutting element 105 are attached to the support structure 4, 5 relative to one another in such a way that the cutting region 104 of the first cutting element 102 is spaced apart in the vertical direction from the second cutting element 105 or above the second cutting element 105 when the plow device 3 rests in the working position on the ground 120 or penetrates the ground.

The rotating cutting element 102 and the second cutting element 105 work together synergistically. On the one hand, a desired plowing depth is kept constant by means of the second cutting element 105, since the cut-off soil ridges 201 press on the second cutting element 105 with a defined compressive force/pull-in force and thus counteract the buoyancy of the rotating cutting element 102. On the other hand, the energetically advantageous effect of the rotating cutting element 102 when cutting the soil ridges 201, in particular the side surfaces or lateral regions 202 of the soil ridges 201, is utilized. Thus, an energy-efficient plow device 2 is provided without negatively affecting the quality of the furrow pattern. In addition, the rotating second cutting element 105 causes the cut-off soil ridge 201 to be pressed in the direction of the first cutting element 102, so that crumbling of the cut-off soil ridge 201 is carried out. Furthermore, due to a lateral force, which is introduced into the first support structure 4 by means of the upstream second cutting element 105, a lateral force induced on the first cutting element 102 during cutting is counteracted, so that easier and better guidance of the plow device 2 with a tractor is made possible.

The first cutting element 102 and the second cutting element 105 are arranged relative to one another on the first and second support structure 4 and 5 such that the second cutting region 107 of the second cutting edge 106 of the second cutting element 105, which cutting region comprises the front half of the cutting element 105, is at a distance x in the plowing direction 110 after the first cutting region 104 of the first cutting edge 103 of the first cutting element 102. Thus, during plowing, the rotating first cutting element 105 first hits the soil ridge 201 laterally and cuts it off from the remaining ground 120 in an energy-efficient manner with the second cutting edge 106 of the second cutting element 105. The first cutting element 105 then cuts a lateral region 202 of a soil ridge 201 with the first cutting edge 103. The second cutting element 105 distinguishes the furrow wall cut with the first cutting element 102. As a result, the subsequent cutting element 102 of the subsequent module can laterally and vertically cut and turn the soil ridge. The soil ridge 201 is then rotated by the curved shape of the first cutting element 102 and its oblique orientation to the plowing direction and deposited in the adjacent furrow. Thus, the first cutting element 102 and the second cutting element 105 cut the soil ridge 201 in an energy-efficient manner, while being kept at the desired cutting depth by the compressive force acting on the second cutting element 105.

A region (approx. half a circular disk) of the second cutting element 105 undercuts the soil ridge 201. A further attachment region of the second cutting element 105, on which attachment region an attachment rod/shaft (axis of rotation 109) for attachment to the first support structure 4 is arranged, is designed on the second cutting element 105 on the side facing away from the first cutting element 102. Thus, during plowing, the attachment rod/shaft runs in an already prepared furrow, thereby reducing the tensile force of the plow device 2.

The support structure 4, 5 is designed in such a way that the first cutting element 102 and/or the second cutting element 105 can be adjusted relative to one another along the plowing direction 110 and/or perpendicular, i.e. vertically to the plowing direction 110. For example, the first cutting element 102 can be slidably attached to the support structure 4 by means of bolt connections 115 which can engage in elongated holes 116 in the first support structure 4. By adjusting the distances between the cutting element 102, the second cutting element 105, and the support structure 4, 5 along the plowing direction 110, the plow device 3 can be adjusted to special conditions of different ground types and used in an efficiency-optimized manner. Furthermore, the elements can be readjusted if the elements warp after the plow device 2 has been used.

Furthermore, the support structure 4, 5 can be designed in such a way that the first cutting element 102 can be adjusted relative to one another along a directional component of the first axis of rotation 108, and the second cutting element 105 can be adjusted along a directional component of the second axis of rotation 109. In particular, an angle between the first axis of rotation 108 and the second axis of rotation 109 can be adjusted. The first cutting edge 103 runs in a first cutting plane, while the second cutting edge 106 runs in a second cutting plane. The first cutting element 102 and the second cutting element 105 are attached relative to one another on the corresponding support structure 4 or 5 in such a way that the first cutting plane and the second cutting plane are not designed to be parallel and are at an angle to one another. For example, an angle between the first axis of rotation 108 and the second axis of rotation 109 is less than 90°, in particular between 45° and 80°.

Accordingly, with the flexible attachment of the cutting element 102 and/or the second cutting element 105 to the support structure 4 and 5, a distance between the cutting region 104 of the first cutting edge 103 of the cutting element 102 and of the second cutting edge 106 of the second cutting element 105 can be adjusted.

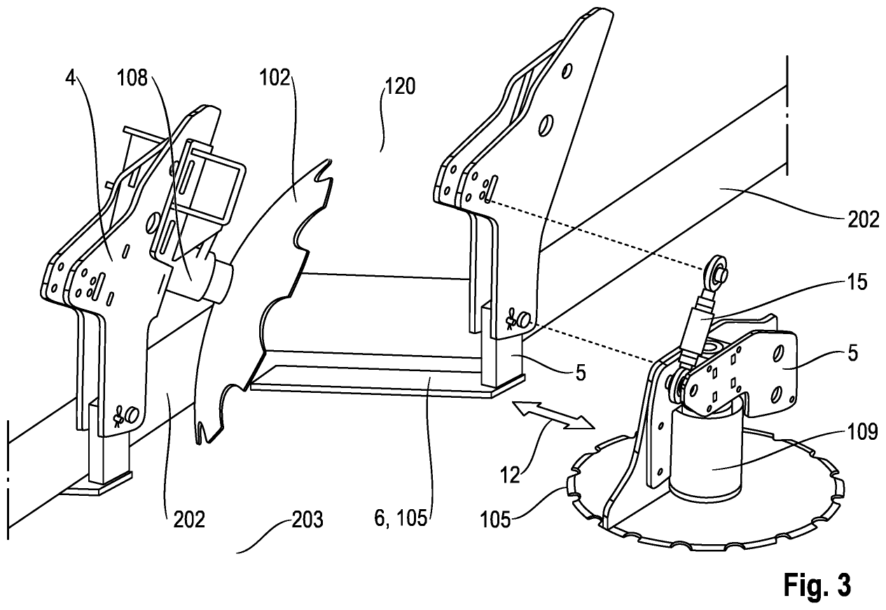

FIG. 3 shows a plow module 1 according to an embodiment of the present disclosure, in which the second cutting element 105 is alternatively designed as a rotating disk 16 or as a fixed cutting blade 6.

The first cutting element 102 and/or the second cutting element 105 can be attached to the corresponding support structure 4 or 5 in a pivotable manner, for example by means of a joint, so that an angle between the first axis of rotation 108 and the second axis of rotation 109 can be adjusted and fixed in a desired position. This possibility is indicated here by way of example by a hydraulic cylinder or a spindle 15 which connects the second cutting element 105 pivotably mounted in the second support structure 5 to the first support structure 4. The position of the first cutting element 102, which is shown here by way of example as a concave disk having a cambered edge, can also be adjusted in relation to the first support structure 4, for example hydraulically. Such a setting can be used, among other things, to influence the width of the furrow 14 formed or the interaction of the two cutting elements 102 and 105.

The first cutting element 102 in FIG. 3 has the shape of a spherical cap and, on its first axis of rotation 108, has a corresponding attachment region which is formed in an attachment plane. The revolving first cutting edge 103 runs within the first cutting plane, with the attachment plane being spaced apart from the cutting plane along the axis of rotation 108. The cutting surface 113 of the cutting element 102 is designed between the revolving first cutting edge 103 and the attachment region.

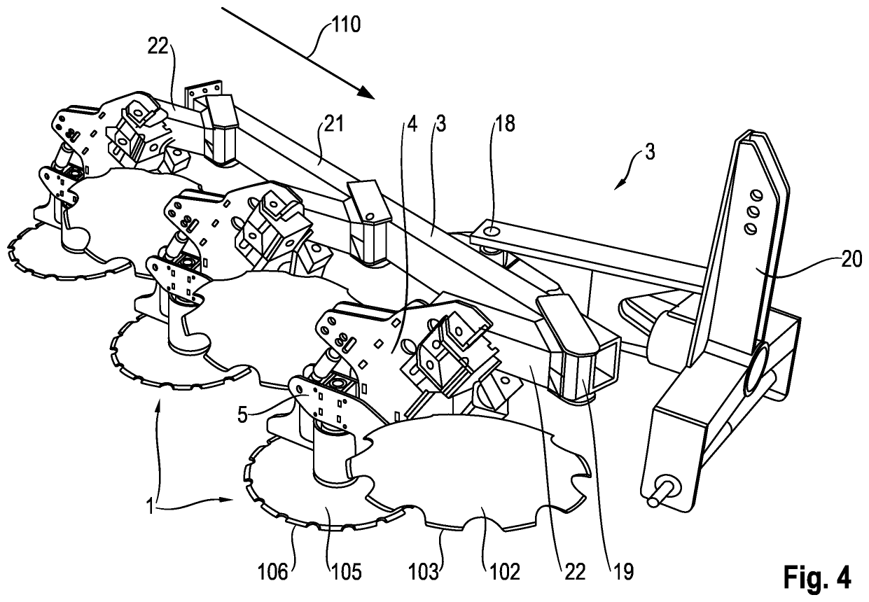

FIG. 4 is a representation of a plow device 2 according to the disclosure as a seedbed plow device, on the base frame 3 of which three plow modules 1 according to the disclosure are shown by way of example. Each of the three plow modules shown has a first cutting element 102 and a second cutting element 105 trailing thereto, which cutting elements are connected to one another on a first support structure 4 and on a second support structure 5 to form a uniform plow module, with the second support structure 5 being pivotably articulated on the first support structure so that the second cutting element 105 can have an at least small, adjustably fixable angle of attack downwards into the soil through the actuator 26.3 (see FIGS. 6 to 9), in order to exert the necessary pressure on the plow device to remain at the desired plowing depth and thus to ensure that the first cutting element 102 designed as a hollow disk is at the desired depth for cutting off the side of the soil ridge. When plowing in the plowing direction indicated by the arrow 110, the first cutting element 102 having the revolving cutting edge 103 for cutting the sides of the soil ridge is in front of the second cutting element 105 having an also revolving cutting edge 106 for cutting the bottom of the furrow. A first coupling part 20 is used to connect the plow device 2 to a tractor, for example, the first coupling part 20 being connected in an articulated manner to the second coupling part 21 which is generally designed to be bar-shaped. In principle, the second coupling part 21 represents the base frame 3. The plow modules 1 are attached to the base frame 3 by means of joints 19.

When pulling over the ground 120, a part of the plow modules penetrates the ground 120 up to a structurally predetermined depth and ejects the soil ridges 201 produced in the process. The plow modules 1 are substantially staggered next to one another, so that a plurality of soil ridges are produced according to their number, as can be seen in FIG. 2. After turning, when leaving the first cutting elements 102, these soil ridges 201 come to rest in the furrow 14 formed by the cutting elements 102 lying in front of them, as is shown in FIG. 2.

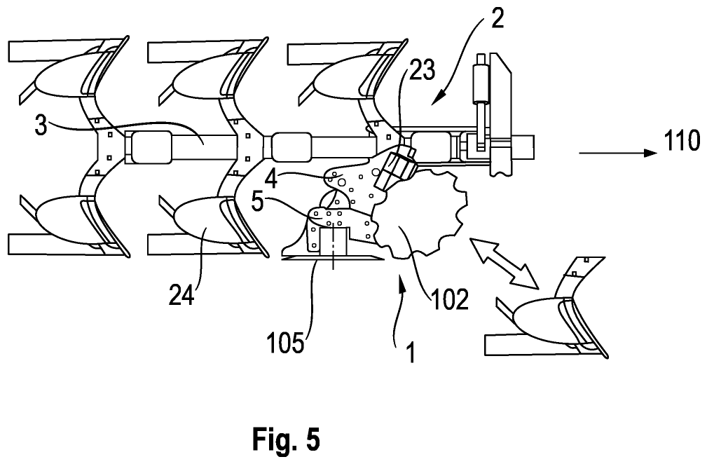

And finally, a plan view of a plow device 3 is shown in FIG. 5, in which six plow bodies 24 are arranged in pairs side by side. The double arrow shows that the plow bodies 24 can be exchanged for the plow modules 1 according to the disclosure. This is particularly easy with regard to the assembly work, because the complete plow modules 1 can be exchanged for the plow body 24 originally mounted on the plow device, without the assembly work being appreciably increased. The plow modules 1 according to the disclosure comprise a first, leading cutting element 102 for cutting the sides of the soil ridge and a trailing cutting element 105 for cutting the bottom of the furrow. The second cutting element 105 is attached to a support structure 5, whereas the first cutting element 102 is attached to a first support structure 4. The support structure 4 and the support structure 5 are connected to one another in such a way that the second support structure 5 can be pivoted in order to be able to adjust the angle of attack of the second cutting element 105 with respect to the bottom of the furrow. The first cutting element 102 can be adjusted in several degrees of freedom, so that the adjustment of the plow width on the one hand and the interaction between the first cutting element 102 and the second cutting element 105 on the other hand can be adjusted as a function of the ground parameters and also with regard to further parameters. For example, the first cutting element 102 is adjustably attached to the first support structure 4 by means of a carriage 23, so that its height with respect to the plane which is cut by the second cutting element 105 can be adjusted.

FIG. 6 is a representation of two plow modules 1 which are attached to a base frame 3 on both sides. The base structure of the plow module 1 described above consists of a support structure 4 to which the first cutting element 102 is attached and to which the second support structure 5 which supports the second cutting element 105 is attached, the first support structure 4 being attached to the base frame 2. A perforated plate 25 is arranged on the first support structure 4 of the first cutting element 102 designed as a hollow disk, which perforated plate allows pivoting of the first cutting element about an axis which is directed substantially perpendicular to the ground to be worked. The pivoting is realized in that an element designed as a disk segment in the form of the perforated plate 25 has bores arranged at a defined grid spacing from one another on the outer circumference. These bores serve to set a pivoting of the hollow disk, i.e. the first cutting element 102, by an angular dimension defined by the grid spacing of the bores. In this embodiment, the cutting angle of the first cutting element 102 is adjusted stepwise. Also shown is a hydraulic actuator 26.3 which can continuously adjust this cutting angle to adjust the cutting angle of the second cutting element 105 when moving through the ground and creating the furrow base. The rest of the base structure corresponds to that which has already been explained, for example with reference to FIG. 1, so that these details are not repeated here. In addition, a connecting element which is designed in the form of a push rod 27 is shown in FIG. 6. The push rod 27 connects all the plow modules attached to the plow device to one another via pivoting plates, so that, during a longitudinal movement of the connecting rod 27, all the plow modules 1 can be adjusted synchronously with regard to their cutting width. The push rod 27 is designed as a square hollow profile and is preferably welded to a sleeve through which a pin representing the corresponding pivot axis passes on the inside.

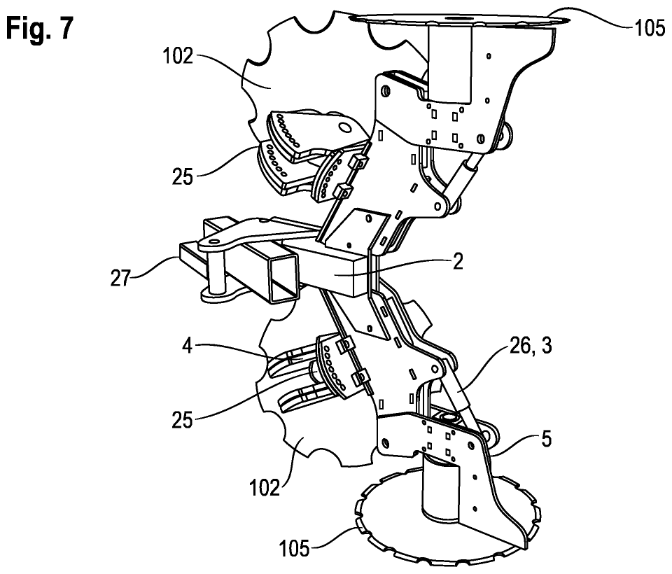

FIG. 7 is a representation of the embodiment according to FIG. 6 in a somewhat different perspective in which the actuator 26.3 for adjusting the cutting angle of the second cutting element 105 and the perforated plate 25 can each be clearly seen. The rest of the structure corresponds to that shown in FIG. 6.

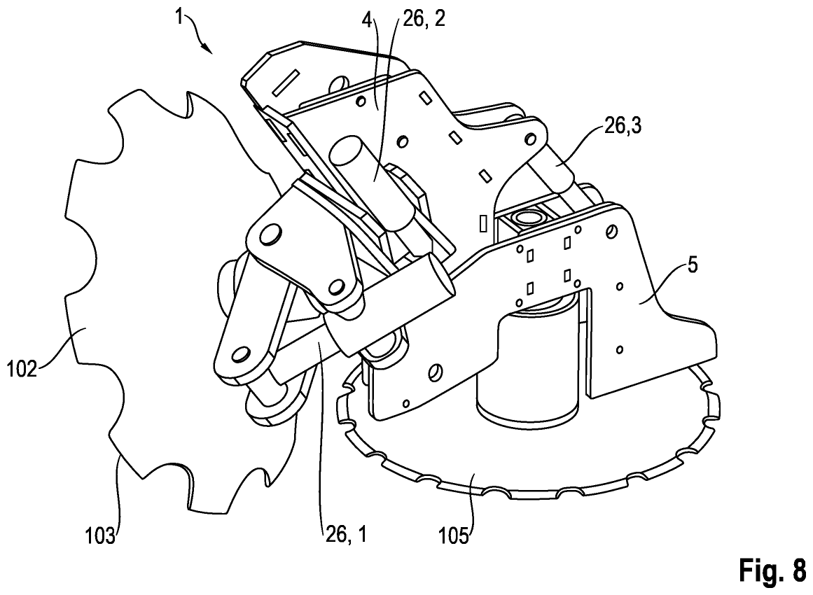

FIG. 8 shows an embodiment of a plow module 1 which corresponds to the base structure according to FIG. 1, but with the possibility of adjusting the first cutting element 102 which is designed as a hollow disk being realized by means of hydraulic actuators 26.1 and 26.2. The actuator 26.1 serves to continuously adjust the cutting angle of the first cutting element 102, which is realized by pivoting the first cutting element 102 about an axis which is directed substantially perpendicular to the ground to be plowed. A second actuator 26.2 is provided, which allows pivoting of the first cutting element 102 about an axis which substantially points in the plowing direction. The respective forces are transmitted by means of articulated lever members, which are known per se to a person skilled in the art and therefore do not need to be explained in more detail here. The rest of the base structure corresponds to that of the plow module 1 according to the disclosure, as already shown and explained in FIG. 1 without the adjustability of the first disk element 102.

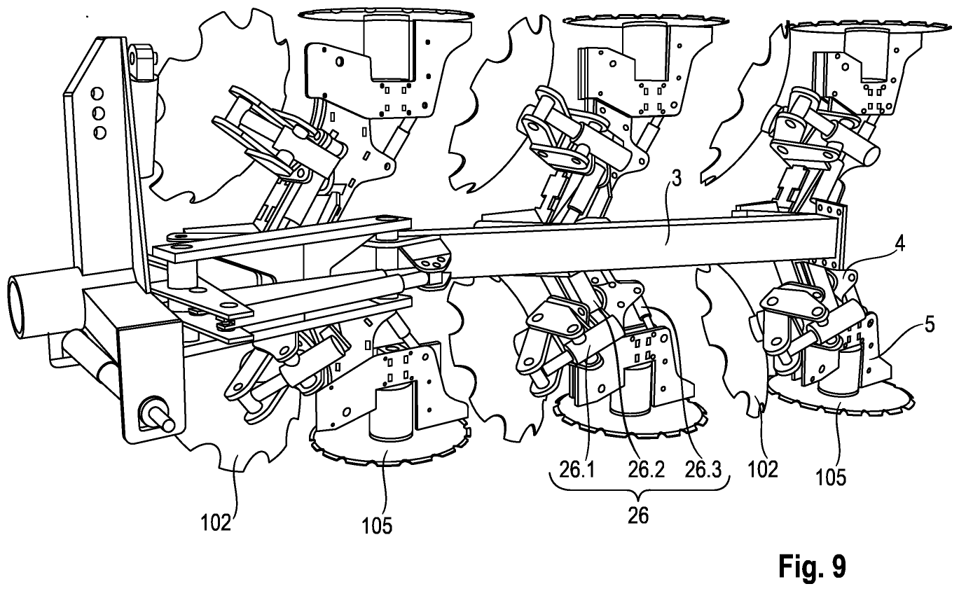

For the sake of completeness, FIG. 9 shows a plow device 2 having six plow modules 1, three each on one side of the base frame 3 or the plow beam, with the base structure otherwise described in FIG. 4. Clearly recognizable are the plow modules 1 provided with actuators 26, by means of which a double-axis pivoting of the first cutting element 102 and a single-axis pivoting of the second cutting element 105 is continuously possible, since hydraulic actuating cylinders are used as actuators.

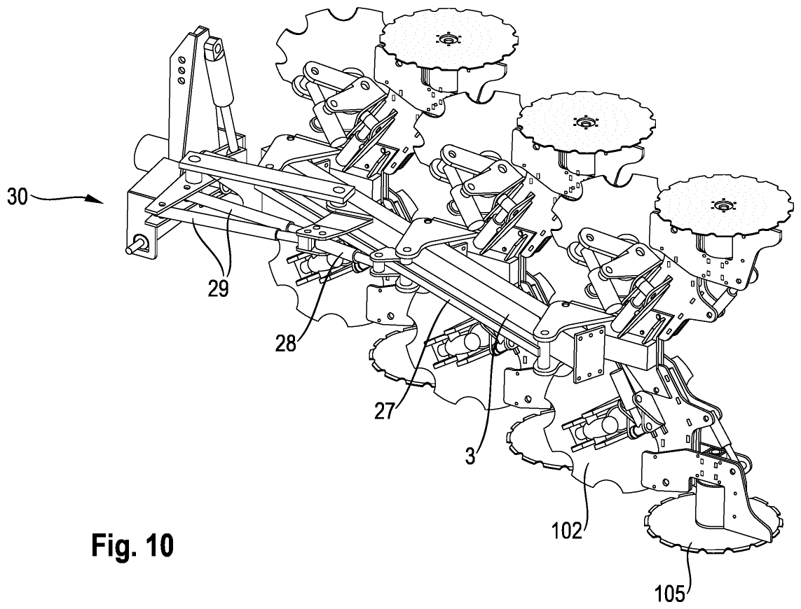

FIG. 10 shows a plow device on which six plow modules 1, three on each side of the plow beam 3, are arranged. The respective pairs of plow modules 1 are firmly connected to a connecting element in the form of a push rod 27 via pivoting elements in the form of approximately triangular pivoting plates. With a longitudinal movement of the push rod 27, the plow modules can be adjusted with regard to their cutting width via the pivoting plates. The corresponding movement of the push rod 27 in the longitudinal direction is brought about by means of a third hydraulic cylinder 28, so that in the case of an actuating movement of the actuating cylinder 28, all hydraulic modules can be adjusted synchronously with respect to their cutting width. In a manner known per se, the pivoting of the plow device according to the disclosure relative to the tractor pulling the plow, for which purpose the plow device is attached to the mounting side 30 on the tractor, is laterally adjusted by a first and a second actuating cylinder 29. It is the third actuating cylinder 28 which causes the simultaneous adjustment of the cutting width of the plow device by means of an actuating cylinder 28 which is connected to the push rod 27. The rest of the base structure consists of the first cutting element 102 and the second cutting element 105, which have been described above, and their function and arrangement are therefore not explained again here.

The rest of the function and the rest of the structure of the plow module 1 as well as the entire plow device have already been described above and are therefore not repeated here.

1. Plow module for interchangeable mounting on a base frame of a plow device for plowing a ground, wherein the plow module comprises:
a rotatable first cutting element which is designed as a coulter disk and has a revolving first cutting edge, wherein the first cutting element is designed in such a manner that a lateral region of a soil ridge in the ground can be cut by moving the plow module on the ground along a plowing direction,
a second, flat cutting element having a second cutting edge, wherein the second cutting element is designed in such a manner that a bottom region of a soil ridge in the ground can be cut by moving the plow module on the ground along a plowing direction, wherein the plow module is designed as a ready-mounted unit, in which plow module the second cutting element follows the first cutting element with its cutting edge in the plowing direction and
a first support structure carries the first cutting element and
a second support structure carries the second cutting element,
the first support structure and the second support structure are connected to one another,
in that the first support structure has means for detachable attachment to a base frame of a plow device,
wherein the first cutting element can be adjusted to be pivotable, in terms of its cutting angle, about an axis running in the direction of the ground to be plowed and/or pivotable, in terms of its pivot angle, about an axis running in the plowing direction.

2. Plow module according to claim 1, wherein the second support structure is pivotably connected to the first support structure via a joint and the angle between the two support structures is adjustable.

3. Plow module according to claim 1, wherein the first cutting element is slidably arranged on the first support structure such that the distance between the first cutting edge of the first cutting element and the second cutting edge of the second cutting element is adjustable.

4. Plow module according to claim 1, wherein the cutting angle of the first cutting element is continuously adjustable.

5. Plow module according to claim 1, wherein the pivot angle of the first cutting element is continuously adjustable.

6. Plow module according to claim 4, wherein the cutting angle and the pivot angle can be adjusted by means of hydraulically or electrically drivable actuators.

7. Plow module according to claim 1, wherein the cutting angle of the first cutting element can be adjusted stepwise by means of a perforated plate with defined hole spacing.

8. Plow module according to claim 1, wherein the pivot angle of the first cutting element can be adjusted stepwise by means of a perforated plate with defined hole spacing.

9. Plow module according to claim 1, wherein the second cutting element can be pivoted in an adjustable manner about an axis running transversely to the plowing direction.

10. Plow module according to claim 1, wherein a first cutting region is formed within a first cutting plane and a second cutting region is formed in a second cutting plane, the first cutting plane and the second cutting plane forming an angle of 30° to 135°, in particular up to 110°, to one another.

11. Plow module according to claim 1, wherein the first cutting element is cambered or has the shape of a cone or a truncated cone.

12. Plow module according to claim 1, wherein the first cutting edge of the first cutting element and/or the second cutting edge of the second, disk-shaped cutting element has/have recesses on the circumference.

13. Plow module according to claim 1, wherein that the second cutting element is a rotatable cutting element and the second cutting edge is a revolving cutting edge.

14. Plow module according to claim 1, wherein that the second cutting element is a fixed cutting blade.

15. Plow module according to claim 1, wherein that the cutting blade of the second cutting element is designed to be L-shaped, with a first bar of the cutting blade being aligned horizontally in the working position of the plow module and a second beam being aligned substantially perpendicular thereto.

16. Plow module according to claim 15, wherein the cutting blade is designed in one piece.

17. Plow device having a base frame, wherein at least one plow module according to claim 1 is arranged on the base frame of the plow device.

18. Plow device according to claim 17, wherein at least two plow modules are arranged on the base frame, the first support structure of a first cutting element and the second support structure of a second cutting element of said base frame being connected to a connecting element which can be adjusted with respect to the base frame in such a way that the plow modules can be adjusted in relation to one another in the width direction of the plow device.

19. Plow device according to either claim 17, wherein the connecting element is a push rod.

20. Plow device according to claim 19, wherein the push rod can be adjusted in a hydraulically or electrically driven manner.
